(19) United States
(12) Patent Application Publication
(10) Pub. No.: US 2018/0299637 A1
(43) Pub. Date: Oct. 18, 2018

(54) Imaging Lens

(71) Applicant: Jia Wan, Shenzhen (CN)

(72) Inventor: Jia Wan, Shenzhen (CN)

(73) Assignee: AAC Technologies Pte. Ltd., Singapore city (SG)

(21) Appl. No.: 15/677,070

(22) Filed: Aug. 15, 2017

(30) Foreign Application Priority Data
Apr. 15, 2017 (CN) 201720420669.5

(51) Int. Cl. G02B 7/02

(52) U.S. Cl. CPC G02B 7/026; G02B 7/021

(57) ABSTRACT

The present disclosure provides an imaging lens. The imaging lens includes a lens barrel having a first barrel wall provided with an optical aperture, a second barrel wall bending and extending from the first barrel wall, and an accommodation space enclosed and formed by the first barrel wall and the second barrel wall. A lens group is accommodated in the accommodation space. The first barrel wall includes an outer wall surface adjacent to an object side; an inner surface for the lens group to lean; and a connecting surface connecting the outer wall surface to the inner wall surface for forming the optical aperture. The connecting surface includes a first optical aperture side wall, a second optical aperture side wall extending to the inner wall surface. The second optical aperture side wall is a Lambertian surface.

### FIELD OF THE PRESENT DISCLOSURE

The present disclosure relates to an imaging lens used in a portable or mobile electronic equipment.

### DESCRIPTION OF RELATED ART

Recent years, with a development of an imaging technology and an emerging of an electronic product with an imaging function, an optical imaging lens has been extensively applied in various products, and improved and optimized constantly. Currently, a direction of improving most of imaging lenses is how to make the imaging lens smaller and thinner, and choose a proper lens with a good degree of adaptability of optical characteristics while making the imaging lens smaller and thinner, and study how to integrate them together to guarantee a good imaging result. However, during capturing an image, because all the light into the imaging lens from various angles will be reflected inside and outside the lens for many times and causes an interference problem from a stray light, which will bring remarkable impact to the imaging quality. Therefore, although a shading piece or shading board is added between the pieces of imaging lens to stop some stray light, these measures can only stop or absorb some stray light, which has relatively smaller role of weakening the stray light as a whole, and can't guarantee the good imaging result.

Therefore it is necessary to provide an improved lens module for overcoming the above-mentioned disadvantages.

### BRIEF DESCRIPTION OF THE DRAWING

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an illustrative cross-sectional view of an imaging lens in accordance with an exemplary embodiment of the present disclosure.

FIG. 2 is an illustrative cross-sectional view of a lens barrel of the imaging lens in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

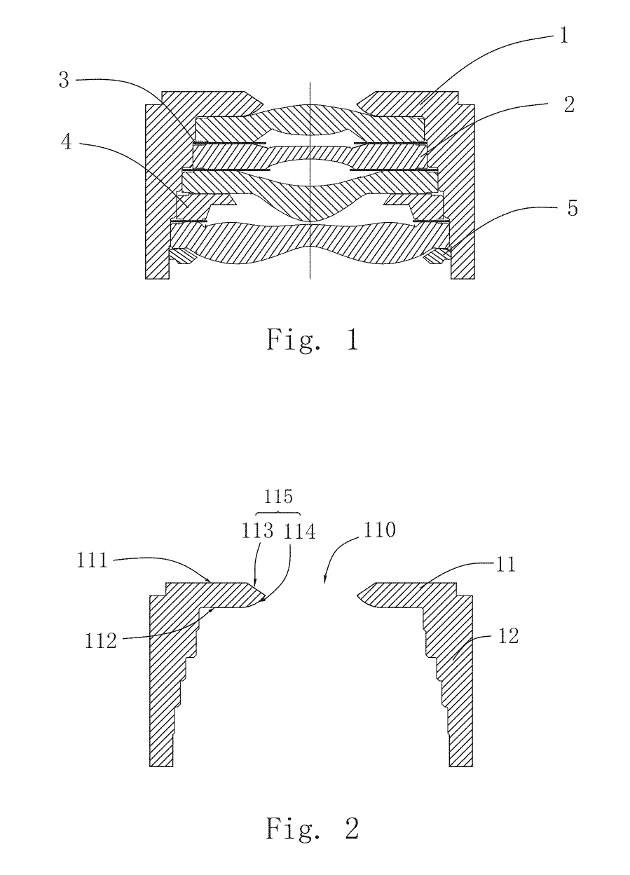

Referring to FIGS. 1-2, an imaging lens in accordance with an exemplary embodiment of the present disclosure includes a lens barrel 1 and a lens group 2 arranged in the lens barrel 1. The lens barrel 1 comprises a first barrel wall 11 provided with an optical aperture 110, a second barrel wall 12 bending and extending from the first barrel wall 11, and an accommodation space enclosed and formed by the first barrel wall 11 and the second barrel wall 12. The lens group 2 is accommodated in the accommodation space. The first barrel wall 11 comprises an outer wall surface 111 adjacent to an object side, an inner surface 112 for the lens group 2 to lean. The optical aperture 110 goes through the first barrel wall 111, and the first barrel wall 11 also comprises a connecting surface 115 that connects the outer wall surface 111 and the inner wall surface 112 that encloses the optical aperture 110. The connecting surface 115 comprises a first optical aperture side wall 113 extending towards the inner wall surface 112 in an inclined manner along a direction of an optical axis from an edge of the outer wall surface 111 adjacent to the optical aperture 110, a second optical aperture side wall 114 extending to the inner wall surface 112 away from the direction of the optical axis from an edge of the outer wall surface from an end of the first optical aperture side wall 113, and the second optical aperture side wall 114 is a convex arc surface, and the arc surface is a Lambertian surface.

In this embodiment, the lens barrel 1 is arranged as above, specifically as shown in FIG. 2, the lens barrel 1 mainly comprises a first barrel wall 11, a second barrel wall 12 and an accommodation space. The first barrel wall 11 mainly comprises an outer wall surface 111, an inner wall surface 112 and a connecting surface 115 enclosing an optical aperture 110 for diffusing an incident stray light from an outside of an imaging lens or an incident stray light formed by reflection in the lens barrel on a side wall 114 of a second optical aperture in an even manner through an arc surface and Lambertian processing of the second optical aperture side wall 114 on a connecting surface 115, which can't be incident into a lens group 2 in a centralized manner, thereby weakening the incident stray light largely, and solving the problem of the stray light efficiently and performing a good imaging quality.

Notably, a Lambertian surface is a kind of nearly ideal diffuse reflection, when an incident illumination is a certain value, observe a reflection surface from any angle, and its reflection luminance is a constant, further, while any incident light from any angle (i.e.: an incident stray light on a side wall 114 of a second optical aperture from an outside of a lens or a stray light formed by a reflection in a lens barrel in this embodiment) is diffused on the Lambertian surface, it will be reflected towards various directions with the same reflection luminance, so that the luminance generated from various direction is the same, in other words, the incident light beam is diffused evenly.

In an imaging lens, because an incident ray on a side wall 114 of a second optical aperture will be reflected towards an incident surface of a lens group 2 by the second optical aperture side wall 114 and form a stray light, in this embodiment, the second optical aperture side wall 114 will be made into a convex arc Lambertian surface that can diffuse a reflection light, in order to weaken a local impact to an imaging of a lens group 2 by a stray light, and improve the imaging quality as a whole.

In this embodiment, the first optical aperture side wall 113 is an inclined surface. As shown in FIG. 2, and the first optical aperture side wall 113 is arranged as the inclined surface being inclined towards an inner wall surface 112 along a direction near a light axis, which can make the incident light into the lens at maximum level, and make the best imaging best in this embodiment with measure of weakening a stray light.

In this embodiment, the lens group 2 comprises at least two pieces of lenses, and a shading piece 3 clamped between any two described adjacent lenses. Understandably, there are at least 2 lenses or 4 lenses or more lenses of the lens group 2 in the lens, and the specific number can be set by demand, in this embodiment, an imaging lens with 4 lenses is used. The shading piece 3 can reduce a reflection of light in a lens barrel, and the shading piece 3 can be set between any two adjacent lenses (or every two lenses) can also cover some incident stray light and reflection of light in an imaging lens efficiently, in order to further avoid an impact to the imaging quality by the stray light based on the condition in which the second optical aperture side wall 114 is set as an arc Lambertian surface.

Understandably, a shading piece 3 can be set as a hollow ring structure, and an amount and location of the shading piece 3 can be decided as the case may be, besides, under the premise where the stray light is stopped efficiently, make it thinner as possible as it can, e.g.: choose more ideal size between 1 mm-5 mm.

In addition, the imaging lens can also comprise a shading board 4, and the shading board is clamped between two adjacent lenses near an image side in the lens group 2. The function of the shading board is similar as the shading piece 3, which can also reduce a reflection of light from an inner wall of a lens barrel, and the shading board 4 is set between two adjacent lenses nearest the image side, which can minimize a stray light that interferes with an imaging result. In this embodiment, preferably, the shading board 4 is set by an object side of the shading piece 3 between two adjacent lenses nearest the image side, understandably, the shading piece can also be clamped between the shading board 4 and an adjacent lens.

In addition, the imaging lens also comprises a press ring 5, and the lens group 2 is clamped between the first barrel wall 11 and the press ring 5. The press ring 5 can tighten the lens group 2 in the imaging lens and the shading piece 3 and shading board 4 etc clamped between the lens group 2, in order to stabilize the structure of the whole lens.

The press ring 5 and the second barrel wall 12 of a lens barrel 1 are connected and fixed, specifically, the press ring can be connected to the second barrel wall 12 by sticking or other methods, and a corresponding location of the second barrel wall can also have a connecting groove to clamp the press ring 5; in addition, the press ring 5 can be a press ring made of metal or plastics. In this embodiment, the press ring 5 is made of plastics, and connected to the second barrel wall 12 by sticking.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An imaging lens, including:
a lens barrel comprising a first barrel wall provided with an optical aperture, a second barrel wall bending and extending from the first barrel wall, and an accommodation space enclosed and formed by the first barrel wall and the second barrel wall;
a lens group accommodated in the accommodation space;
wherein
the first barrel wall comprises
an outer wall surface adjacent to an object side;
an inner surface for the lens group to lean;
a connecting surface connecting the outer wall surface to the inner wall surface for forming the optical aperture, the connecting surface comprising a first optical aperture side wall extending towards the inner wall surface in an inclined manner along a direction of an optical axis from an edge of the outer wall surface adjacent to the optical aperture, a second optical aperture side wall extending to the inner wall surface away from the direction of the optical axis from an edge of the outer wall surface from an end of the first optical aperture side wall, the second optical aperture side wall being a Lambertian surface.

2. The imaging lens as described in claim 1, wherein the first optical aperture side wall is an inclined surface.

3. The imaging lens as described in claim 1, wherein the lens group comprises at least two pieces of lenses, and a shading piece located between two adjacent lenses.

4. The imaging lens as described in claim 3 further comprising a shading board located between two adjacent lenses nearest an object side in the lens group.

5. The imaging lens as described in claim 3 further comprising a press ring, and the lens group is located between the first barrel wall and the press ring.
